(19) United States
(12) Patent Application Publication
(10) Pub. No.: US 2009/0321511 A1
(43) Pub. Date: Dec. 31, 2009

(54) METHODS AND SYSTEMS FOR RECYCLING AND RE-USE OF MANUFACTURED ITEMS

(76) Inventor: Rutherford Peter Bruce Browne, Bellingham, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/294,012

(22) PCT Filed: Apr. 4, 2007
(86) PCT No.: PCT/CA2007/000546

§ 371 Date: Apr. 2, 2009

Related U.S. Application Data
(60) Provisional application No. 60/789,531, filed on Apr. 4, 2006.

(51) Int. Cl. G06F 17/00; B09B 3/00; B23P 19/00; G06F 17/30; G06F 7/00; G06Q 10/00; G06Q 50/00

(52) U.S. Cl. 235/375; 209/629; 707/3; 700/226; 700/225; 705/7; 235/462.1; 235/439

(57) ABSTRACT

The described embodiments involve the use of an information medium, such as a Barcode, Radio Frequency Identification Device (RFID) tag or other machine readable medium, such as may be readable by Optical Character Recognition (OCR), to identify a manufactured item. Alternatively, a Machine Vision Identification System (MVIS) may be used to facilitate the identification of the item. Once an item is identified, the materials and subassemblies it is made of may also be identified and used to facilitate its repair, replacement, refurbishment, remarketing and recycling by either a human or robotic device or combination thereof.

### TECHNICAL FIELD

The present invention relates to methods and systems for automated re-use and/or recycling of manufactured items and/or their component parts. In particular, the invention relates to methods and systems for automated performance of some of the steps involved in the re-use and recycling of manufactured items, such as consumer goods and business equipment items that have residual value or that may otherwise be recycled.

### BACKGROUND

It is not uncommon for a person or corporation to purchase new items and simply throw away their old items. For example, when a person or corporation buys new electronic equipment, it is common to throw away the old equipment or in the absence of a clear alternative, to simply store it. Such items often have unrealized residual economic value and/or environmental liabilities attached to them. For example, used electronic equipment can be re-sold if it can be matched up with a prospective purchaser. Alternatively, components such as memory chips could be extracted and re-used in other products.

A significant barrier to extracting the residual economic value out of used items and/or mitigating the cost of processing it in the optimal environmental way (particularly older and/or lower value items) is the cost associated with having a person (often a trained professional) identify the product, the accessory items required and the location and/or acquisition of the user and maintenance documentation, the materials it is composed of and/or the environmental hazards associated with processing the item. This process can be immensely time-consuming and generally requires that the item must be transported to a trained person or the trained person must be transported to the item so that a person can physically identify the item, the parts of it that have residual value, the parts that have no residual value and the parts of it that represent environmental hazards.

In addition, manufactured products are typically delivered to the original consumer with all items required to use the product and either information on how to service the product or where to obtain service. However, it is a common problem to find that one or more of the required items and relevant information, supporting documentation and/or packing that normally accompanies the item to have been lost or misplaced when it is subsequently passed onto someone else to use, which results in the item often having significantly reduced or even negative utility and/or value.

For example, a cellular phone requires, and is typically sold with, a battery, charger, operating instructions and in many cases a disk containing additional device software. If the phone is placed together with its battery and charger into a group of similar items and is subsequently separated from its battery and charger, then the labor required to sort through the items and try to locate the right accessories would likely be prohibitively expensive and thus all the phones and accessories in the box may be thrown away or recycled as low value mixed materials. Even the loss of the item's operators' manual and/or supporting software can often be enough to make the product unusable and/or uneconomical to repair, remarket or re-use in any other way.

Most manufactured items that have reached the end of their useable life are difficult to economically recycle in a responsible way. Waste electronic and electrical equipment in particular, or “E-Waste” as it is commonly known, is recognized as one of the fastest growing and difficult-to-handle components of the modern waste stream. Many electronics items contain hazardous materials and are made up of a large amount of mixed materials. Unless these materials are separated, they have a low or negative value as raw materials for the manufacturer of other products because the materials contaminate each other. For example, if a printer toner cartridge is not removed from printer before the printer is fed into a metal shredder, the residual toner can cause a significant safety hazard when it's released into the air during shredding.

The average computer, for example, contains a mixture of plastics, steel and other materials ranging from precious metals, such as gold and silver, to hazardous materials such as mercury, cadmium and lead. The low value plastic case and steel chassis typically contain enough pure and discrete materials in them to make them worth recycling. This is not economically viable if the process of separating and correctly identifying the chemistry of the materials involves using human labor, as it is usually too complex, too expensive or too dangerous to be environmentally sustainable or economically justifiable to do it. For example, one current practice is to remove the plastics from the item and to have third world labor identify the chemical composition of the plastic by burning a small portion of it with a disposable cigarette lighter and smelling the resultant smoke.

The result is that most modern used electronic equipment recyclers are forced by current economics to simply shred the whole item, smelt the remains (burning the plastic) and therefore produce a much lower amount of re-usable material and high amount of hazardous mixed material waste. Furthermore, smelters that usually target the recovery of one set of metals (say base metals such as steel) usually do so using a process that is at the expense of other set of metals (i.e. precious metals, such as gold).

The current best process that maximizes the value of the item, the components and materials it is composed of, while minimizing the environmental impact, and mitigating the legal concerns of recycling say a desktop computer, for example, is roughly as follows: manually remove all the screws that hold the case and sub-assemblies to the chassis and separate them; manually identify, all subassemblies by reference to photos in parts catalogs; manually identify, remove and recycle the backup up battery (if any); manually identify, evaluate and remove any and all components that contain high quantities of precious metals, such as the Central Processing Unit, memory and other high value chips; manually identify and remove the hard drive and either connect to a device that can electronically erase its contents so it can be re-used or disassemble it and/or render its recording surfaces unusable by physical means, such as shredding it; manually conduct individual metallurgical tests on the remaining major metal components and then remove and segregate these components by metallurgy for recycling; and manually conduct individual chemical composition tests on the remaining plastic components and then segregate these components by composition and color for later use in the manufacture of other plastic items.

While this approach allows one to recognize the currently best-available return on the inherent value of the components materials used to construct the desktop computer, it is simply not economically viable to process items this way because: it requires expensive trained labor to identify and item and decide whether it should be re-used or recycled; the cost of using labor to disassemble it is expensive; skilled labor is required to manually identity the actual components and the chemical compositions of individual materials contained therein, which is even more expensive; and any process, which relies on human intervention/interpretation, is by its nature subject to error and therefore will result in at least some percentage of the recovered material being contaminated with due to identification errors and even small amounts of contamination can substantially impact the value of a batch of recovered material.

Because in most cases it is not currently economical to manually sort re-usable items, disassemble items to be recycled and sort the materials they are made of, most attempts to automate the recycling processes involve feeding the item into a industrial shredder, reducing the item to small pieces and then use a variety of techniques such as magnets, and air eddy currents to separate out the different materials. It is, for example, common practice to recycle automobiles by feeding them into a giant shredder. While this can be reasonably effective at separating out ferrous material from non-ferrous material, it is not very effective at separating out types of plastic or multiple substances contained within small components located close to each other, such as chips on a computer board. As a result, shredding usually results in a lot of low grade materials which typically have many impurities in them. Shredding can also result in a lot of material that contains small amounts of so many different types of material (i.e. plastic and fiberglass) that it has no downstream economic value to it and is commonly sent to a landfill.

An object of the present invention is to provide improved methods and systems for one or more of identification, re-use, refurbishment and recycling of manufactured items, or to at least address or ameliorate problems or shortcomings associated with previous methods for re-use or recycling of items.

### BRIEF DESCRIPTION OF THE DRAWINGS

Embodiments of the invention are hereinafter described in further detail, by way of example only, with reference to the accompanying drawings, in which:

FIG. 1 is a schematic diagram of a system for recycling a manufactured item, according to some embodiments;

FIG. 2 is a flow chart of a method of recycling a manufactured item, according to some embodiments;

FIG. 3 is a block diagram of a facility for recycling manufactured items, according to some embodiments; and

FIG. 4 is an example of a two-dimensional barcode.

### DETAILED DESCRIPTION

Certain embodiments relate to a system for recycling a manufactured item having at least one information medium attached thereto for storing or representing item information associated with the item. The system comprises: information reading apparatus for automatically reading the at least one information medium; an information processing system in communication with the information reading apparatus for determining item information from the at least one information medium, the item information including item identification data, and for determining disassembly instructions based on the item identification data; and robotic disassembly apparatus in communication with the information processing system and responsive to the disassembly instructions to disassemble the item according to the disassembly instructions into item components and to separate the item components for separate recycling of the item components.

The item identification data may comprise a link to disassembly instructions accessible to the information processing system. The system may further comprise a database accessible to the information processing system and storing a plurality of data records, each of the plurality of data records corresponding to a manufactured item, and may comprise disassembly instructions for the manufactured item wherein the information processing system is configured to access the database using the item information to determine the disassembly instructions.

Each data record may further comprise constituent data identifying constituent components of the manufactured item. Each data record may further comprise dimensional data defining physical dimensions of the manufactured item.

The system may further comprise transport apparatus for transporting the separate item components to respective component stations for further processing. For each item component, the further processing may comprise at least one of: transport to a recycling station; storage; further disassembly; shredding; and labeling the item component with a further information medium comprising a unique identifier of the item component.

The information processing system may be configured to determine whether the manufactured item satisfies a cost function based at least in part on the constituent data, wherein if the manufactured item is determined to satisfy the cost function, the information processing system provides the disassembly instructions to the robotic disassembly apparatus to disassemble the manufactured item. If the manufactured item is determined not to satisfy the cost function, the information processing system may instruct the robotic disassembly apparatus to transport the manufactured item to an alternative processing station.

The system may further comprise an image database and an image capture system in communication with the image database for capturing and processing images of the manufactured item or of at least one of the item components and accessing the image database to identify the manufactured item or the at least one item component.

The constituent data may identify one of: all constituent components of the manufactured item; and partial constituent components of the manufactured item and one or more references to data records in the database corresponding to item components.

Further embodiments relate to a recycling facility comprising a plurality of systems as described above, wherein the systems cooperating to recycle a plurality of manufactured items and item components. At least some of the systems may operate in parallel to separately process manufactured items. At least some of the systems may operate in series to process a manufactured item and its item components.

Other embodiments relate to a method for automated recycling of a manufactured item having at least one information medium attached thereto. The method comprises: automatically reading the at least one information medium; determining item information associated with the item based on the at least one information medium, the item information including item identification data determining item disassembly data based on the item identification data; causing a robotic disassembly system to automatically disassemble the manufactured item according to the item disassembly data into item components; and separating the item components for separate recycling of the item components.

Determining the item disassembly data may comprise accessing a database storing a data record comprising the item identification data and the item disassembly instructions. Each data record may further comprise constituent data identifying constituent components of the manufactured item. Each data record may further comprise dimensional data defining physical dimensions of the manufactured item.

The method may further comprise transporting the separate item components to respective component stations for further processing. For each item component, the further processing may comprise at least one of: transport to a recycling station; storage; further disassembly; shredding; and labeling the item component with a further information medium comprising a unique identifier of the item component.

The method may further comprise determining whether the manufactured item satisfies a cost function based at least in part on the constituent data and, if the cost function is satisfied, disassembling the manufactured item. If the cost function is not satisfied, the method may comprise transporting the manufactured item to an alternative processing station.

The method may further comprise capturing and processing images of the manufactured item or at least one of the item components and identifying the manufactured item or the at least one item component based on the images.

Other embodiments relate to a system for facilitating recycling of a manufactured item having at least one information medium attached thereto for storing or representing item information associated with the manufactured item. The system comprises: information reading apparatus for automatically reading the at least one information medium; an information processing system in communication with the information reading apparatus for determining item information from the at least one information medium, the item information including item identification data and item constituent data, and for determining whether the manufactured item satisfies a cost function based at least in part on the item identification data and the item constituent data; and automatic handling apparatus in communication with the information processing system for processing the item for disassembling and recycling of the item if the information processing system determines that the cost function is satisfied and for processing the item for disposal if the cost function is not satisfied.

Further embodiments relate to a method for automated recycling of a manufactured item having at least one information medium attached thereto, the method comprising: automatically reading the at least one information medium; determining item information associated with the manufactured item based on the at least one information medium, the item information including item identification data and item constituent data; determining whether the manufactured item satisfies a cost function based at least in part on the item identification data and the item constituent data; processing the manufactured item for disassembling and recycling of the item if the cost function is satisfied; and processing the manufactured item for disposal if the cost function is not satisfied.

The machine readable information medium is referred to herein as a Full Use Label (FUL). Embodiments may make use of machine vision and pattern recognition algorithms to efficiently identify items that have been manufactured without the inclusion of a machine readable means of identifying them and/or that were originally manufactured with an adequate means to identify them but which such feature was subsequently lost or damaged. This can be done using a Machine Vision Identification System (MVIS) such as is known in the art.

Embodiments may perform collection and storage within a central database of all the pertinent information required to identify the product and maximize the usability and recycleability of an item (the “Full Use Database” or “FUD”).

Embodiments of the invention make use of robotics to efficiently disassemble items that have reached the end of their useful life in their current form and maximize the residual value that may be recovered from the materials and components from which they were constructed (“Robotic Disassembly” or “RD”).

Ideally, the item would have has at least one machine readable information medium attached thereto for storing or representing item information associated with the item. Failing that, the item may be identified using MVIS and the relevant information would be retrieved from the FUD.

The system relies on the machine readable information medium to attach or link to all the relevant information to a product to maximize its usability and recycleability in an offline or online environment. Alternatively, the MVIS may be used to identify an item and access the needed data in situations where the original means of identification has been lost or damaged. Once the item is identified, data and instruction on an efficient means to disassemble the item (if it is to be recycled) or refurbish the item (if it is to be re-used) can be retrieved. The information medium is electronically readable by the information reading means to determine the item information. The item information includes a comprehensive collection of information including item identification data, chemical and metallurgical composition and item disassembly data etc. The item disassembly data may comprise disassembly instructions or a link to disassembly instructions.

The information processing means is configured to process the item information to generate disassembly commands corresponding to the disassembly instructions for causing the robotic disassembly means to disassemble the item according to the disassembly instructions into item components. The robotic disassembly means separates the item components for further separate processing (if required) and recycling of the item components.

Many high volume manufactured items are currently assembled using robotic assembly systems. For many such items, the same robotic assembly systems may be used to disassemble the items by executing the assembly instructions in reverse. For other items, different disassembly procedures may be required and different tools may be necessary to perform the robotic disassembly. For such cases, those skilled in the art of robotic automation will understand how to program the robotic assembly or disassembly systems appropriately to perform the necessary item disassembly.

The information medium may be any form of electronically (including optically) readable medium which allows for the adequate identification of the item and subsequent retrieval of the data necessary to process the item. For example, the information medium may comprise one or more of: printed symbols on an Optical Character Recognition (OCR) readable manufacturers identification label, a one or two-dimensional bar code, a radio frequency identification (RFID) tag or other form of passive information storage medium that may have a transceiver, or the information medium may be an active (storage and transceiver) device which relies on a battery or other power source for powering an electronic response to interrogation by the information reading means. The item may also be identified through the use of digital cameras and scales coupled with pattern recognition algorithms to compare the physical characteristics (size, shape and color) of items coupled with weight, for which identification is sought against a database of items on file.

Given the externally visible physical similarities that can exist between items, the identification process may be a multi-part process that uses mechanical and robotic devices to orientate the item. For items having an external casing, the identification process may include identifying fasteners used to hold the external casing in place and guiding a robotic tool (such as a screwdriver) to remove the fasteners used to fasten the casing to the remainder of the item. In most situations, once the casing has been removed, the item will present a much more unique visual image for identification by MVIS. As the process of locating and removing fasteners and removing components and/or subassemblies is repeated, a series of images may be captured and compared against a database of images.

Many items use common subassemblies, such as disk drives and memory chips, and the presence of these alone is not unique enough to support conclusive identification of a product. However, as the location of these subassemblies in relation to each other is widely variable, images of such subassemblies are expected to provide at least some uniquely identifying information to the information processing system to enable identification of the item.

Additionally, because printed circuit boards are so uniquely different between models of products, as is the location of the individual electronic components and printed circuits that connect them, they provide for a “finger print” level of accuracy of identification which can be recognized by a pattern recognition system. The goal is to capture enough images to enable the system to conclusively identify the make and model of the product, and from there all the relevant information can be accessed from the FUD, which will enable the information processing system to establish what, if any, high value or hazardous subassemblies, components and/or materials are contained within, where they are located, how they should be extracted, repackaged and labeled for easy storage and later retrieval without the need for human interaction.

Items which prove not be located in the database (FUD) will have their relevant characteristics measured, observed and captured and added to the FUD for all users to be able to use the next time an identical item is received for processing.

One of the other challenges with the manual processing of items is that the stream of product presented for re-use and/or recycling is often not of a consistent model or type, which makes manually researching individual items, switching disassembly tools, and identifying, removing, labeling and remarketing items uneconomical. The described embodiments make it much more practical to do this, as a robot is able to retrieve the data required to switch between products much faster and more accurately than a human can.

Certain aspects of the invention address one or more of the problems associated with extracting the residual economic value from manufactured items. Further, these aspects can significantly raise the value and utility of the items in the hands of the subsequent owner by enabling the user to accurately identify an item and readily retrieve all the requisite data to be able to gain maximum use and value from the items directly from the FUL located on the item itself thus eliminating the need for online access to the FUD. Furthermore the process can significantly reduce the environmental impact and related economic costs associated with E-Waste through the facilitation of the economic re-use of the item, its subassemblies, components and/or base materials and the subsequent reduction in the amount of material that needs to be land filled and/or reduces the environmental impact of extracting additional natural resources to build new products that is instead made from recycled materials

Other aspects of the described embodiments address problems associated with recycling manufactured items by enabling an automated system including a robot to read the information medium and obtain instructions on how to sort, disassemble and reprocess the item without human intervention. This allows robotic systems to process an assortment of household electronic items one by one, read the information medium and make a determination as to what the item's value is and how it should be processed for recycling. For example, the robotic system may proceed to disassemble a television (TV) to the point where the plastic case is extracted and placed in a bin containing identical types of plastics (which may then be sold as a high quality, lightly or uncontaminated raw material for use in making other plastic items). The other TV modules (for example, such as the display, power supply and main circuit board) can be disconnected from each other and the power supply module used for assembly in another device. The main circuit board may be retained (because the FUD or another database shows it to have sufficient residual value to justify its retention) and resold to repair another TV of the same make and model, and the display may be recycled under hazardous waste protocols.

The described embodiments involve the use of an information medium, such as a Barcode, Radio Frequency Identification Device (RFID) tag or other machine readable medium, such as may be readable by Optical Character Recognition (OCR), to identify a manufactured item. Alternatively, a Machine Vision Identification System (MVIS) may be used to facilitate the identification of the item. Once an item is identified, the materials and subassemblies it is made of may also be identified and used to facilitate its repair, replacement, refurbishment, remarketing and recycling by either a human or robotic device or combination thereof.

The use of a one or two dimensional barcode label or RFID using a common adhesive is preferable as they are both cheap and reliable means of machine readable identification.

In addition to any existing coded identification label, for example comprising a Universal Product Code (UPC), European Article Number (EAN), Japanese Article Number (JAN) or Global Trade Identification Number (GTIN), which are globally recognized unique numbers, that identifies items, the FUL may have further item-specific data, such as data defining its constituent components embedded within in its data structure, or may provide a link, reference or record locator to a data record in a computer database (FUD) that contains the further item-specific data.

Item-specific data elements stored in the FUD or FUL may include one or more of the following elements: GTIN; UPC; EAN; JAN; the manufacturer's name; the brand name; the model of the item; the manufacturer's part number the manufacturer's serial number; the manufacturer's Internet universal resource locator (URL); a generic description of the equipment (i.e. Toaster, Sewing machine, Eye glasses, Heart Monitor etc.); the SIC code of the division that made the item; the configuration of the item (i.e. 4 Liter engine, 3.5 diopter graduated lens etc.); the first date of production; the date the particular item was produced; the dimensions; the actual weight; the volumetric weight; any special handling requirements; the Harmonized Customs Commodity Code; the materials that make up the item (i.e. ABS plastic, 24 karat gold, iron etc.); the amount or percentage by volume or weight of the elements, materials or substances that make up the product (e.g. ABS plastic, iron, copper); a list of hazardous materials contained within the item (e.g. Nickel Cadmium Batteries, radioactive materials, PCB laden oil etc.); the original list price and currency; the GTIN, part numbers and description of any required accessories (i.e. power supplies, cables, software); the GTIN, part numbers and descriptions of any optional accessories (i.e. power supplies, cables, software); the GTIN, part numbers and description of any consumables (i.e. printer cartridges, lubricants etc.); the GTIN, part numbers of principle subassemblies (i.e. hard drives, Display modules, Engines, transmissions etc.); the GTIN, part numbers and description of any packaging materials required for shipment (i.e. cardboard boxes and foam inserts etc.); additional device software (i.e. printer driver for loading onto a PC); a link (URL) to additional device software; detailed user's manual; the user's manual part number; URLs to a comprehensive current user manual; a detailed service manual; the service manual part number; URLs to a comprehensive current service manual; a decommissioning manual (to make the item safe and/or prepare for re-shipment); the decommissioning manual part number; URLs to a comprehensive current decommissioning manual; a human disassembly manual (for human disassembly); a human decommissioning manual part number; URLs to a comprehensive current human decommissioning manual; robotic disassembly manual (for automatic robotic disassembly); the robotic decommissioning manual part number; URL to a comprehensive current robotic decommissioning manual; hazardous material (HazMat) notices (ideally multi-lingual); standard safety advisories; security restrictions; resale restrictions; a URL link to possible recall notices and new safety advisories; notes and documents; any other relevant URLs; a unique serialized coupon number to facilitate recycling rebates; a list of recycling deposits/rebates/fees applicable for the item and/or URL linking to updated information; and/or whether single use or multi-use is allowed.

The above list may include any other data elements that would facilitate the repair, replacement, refurbishment, remarketing, recycling and re-use and help reduce the misuse (by either a human or robotic device) of the item.

The manuals and documents may contain one or more of the following: text, graphics, audio, video and/or machine language instructions for use by an automated device. The manuals and documents may be in one or more languages.

The inclusion of relevant URLs within the FUL enables the person in possession of the item to reference the most recent version of the relevant data. There may be one or more URLs in each data element category. For example, there may be one URL directing the user to the information the Original Equipment Manufacturer (OEM) has on file and a second URL that identifies the location of the same information on FUD which would stand as a central repository to ensure that, if the product outlives the life of the OEM that made it, relevant information is still available on the product. This point has important environmental considerations, as humans often retain products that have outlived the companies that made them as antiques. Often the items can contain hidden hazards that either were not known at the time they we made and/or are not indicated on the item (i.e. lead-based paint on antique children's toys).

The inclusion of the Harmonized Customs Commodity Code, Country of origin and export license coding may greatly facilitate customs and security handling of products across international borders and make record keeping much more accurate, as well as make it economically viable to collect data on the intra-country movements of products if desired.

The weight and dimension elements and special handling requirements enables the automation of the packing and shipping processes and eliminates the need for successive handlers of the product to weigh and measure a product as it is shipped through the supply chain.

The inclusion of Hazardous Materials documentation would ensure that wherever the product ends up that the relevant Hazardous Materials information is immediately available. The inclusion of safety advisories and the location of product recall notice information may significantly improve the availability of safety information and all of the above could me made available in the language of the user. A prime example of this would be the identification of Pharmaceutical products. Often these products are sent from the stores of donor countries and given as aid to other countries in times of crisis. The problem is that they are often unusable by the local population as they cannot read the donor countries language and/or are unfamiliar with the brand of the product and its use.

The inclusion of a Recycling Rebate number, together with a table of the relevant jurisdictions that offer a recycling rebate, the amount of such rebate and/or the inclusion of a URL that references this information, enables an automated device to efficiently identify and process products that have recycling rebates attached. (e.g. beverage containers and automotive tires and batteries). The Rebate number may also be read and used to record that a product has been received by an authorized recycler, thus formally recording the elimination of the OEM's environmental liability for the product and reducing the potential for more than one recycler to collect a rebate for the same item.

The common description information may follow a standard format i.e. Aspirin. If this information is then provided in a multilingual format, this would greatly facilitate the utility of a product. (i.e. an English speaker could go into a drug store in Japan and use a portable reader to read the FUL to verify that the drug they were about to take is in fact an Aspirin).

Some items, such as hypodermic needles and heart pace-makers, for example, are commonly designated as single use devices, which can be identified using the FUL on the item. Security and Resale restrictions may apply depending on which part of the world the product is located in. For example, many used medical devices can only be refurbished and resold by licensed parties. Additionally, a number of types of technology are governed by US export restrictions and cannot be sold to prohibited countries.

It is envisioned that the FUL would be used for a wide range of purposes and would likely become as great an enabling technology for a wide range of new industries just as the Internet has become.

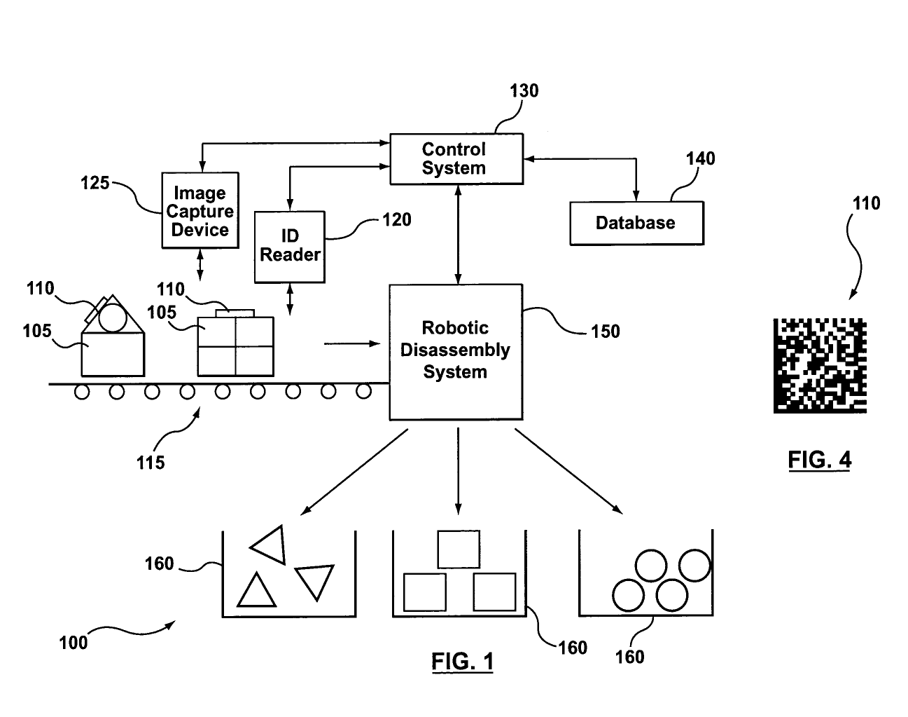

Referring to FIG. 1, there is shown a system 100 for recycling a manufactured item 105. System 100 comprises transport apparatus, such as a conveyor 115, for conveying items 105 past an information reading apparatus, such as identification (ID) reader 120. Each item 105 has a label 110, such as a barcode, RFID tag or other machine-readable information storage medium, located thereon. An example of label 110 is shown in FIG. 4, in the form of a two-dimensional bar code. Label 110 is referred to herein as a full use label (FUL). Each item 105 comprises one or more item components, one or more of which may have a label 110 attached thereto.

System 100 further comprises a control system 130, image capture device 125, database 140, robotic disassembly system 150 and component receptacles 160. Control system 130 receives item identification information from ID reader 120 based on information read from label 110 on each item 105.

Control system 130 is an information processing system that uses the item identification information to query database 140 to determine information relevant to disassembly, recycling, re-use or safe disposal of the item or components in the item. Control system 130 controls robotic disassembly system 150 to receive items 105 from conveyor 115. The robotic disassembly system 150 uses existing robotic machinery and control protocols to disassemble each item 105 according to the item disassembly information retrieved from database 140.

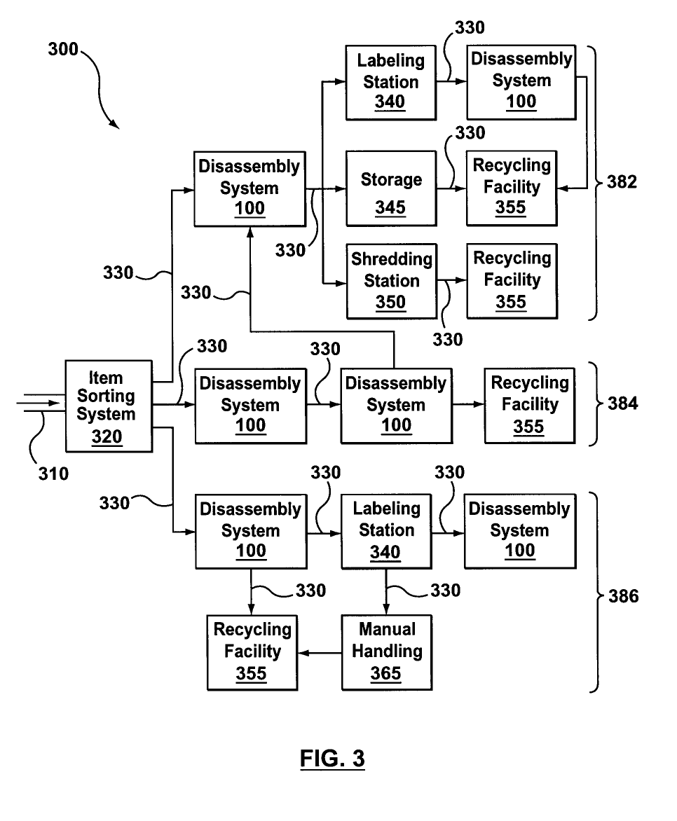

Robotic disassembly system 150 may comprise further conveyors or other means for transporting item components to component receptacles 160 or further processing stations. While only three component receptacles 160 are shown in FIG. 1, the number of component receptacles can be very large to accommodate a large variety of different component types. Each component receptacle 160 contains components or subcomponents of a particular type, composition or category, which for reasons of efficient re-use, recycling or disposal, are most suitably grouped together. Item components in component receptacles 160 may be provided to one or more further processing stations similar to system 100 for further processing, such as is shown in FIG. 3. Such further processing may include any of: further disassembly, labeling with a further label 110, shredding, storage, manual handling and transport to another location.

Control system 130 includes one or more computer processors (not shown) executing one or more software modules (not shown) in the form of computer program instructions which are stored in a memory (not shown) of control system 130. Control system 130 preferably has access to public networks, such as the Internet, for accessing public information repositories in addition to database 140, if necessary. Database 140 may be a dedicated, distributed or virtual database accessible over a local network to which control system 130 is connected. Alternatively, database 140 may be accessible to control system 130 over a public network such as the Internet.

Database 140 preferably stores item information of the types described in detail above. Database 140 may be a distributed or virtual database. Database 140 is also referred to herein as a full use database (FUD). The image capture device 125, together with control system 130 and database 140, comprise a machine vision identification system (MVIS) for identifying item 105 or components thereof when a label 110 is not present. Database 140 stores images of various existing items for comparison with captured images of items 105 to assist in identifying items 105. Optionally, robotic disassembly system 150 forms part of the MVIS if partial disassembly of the item is required to enable identification.

ID reader 120 may include one or more suitable known reading devices for reading one or more label types. Although not shown in FIG. 1, system 100 may further include robotic apparatus for rotating or otherwise moving items 105 so as to more readily present label 110 to ID reader 120 for reading thereof.

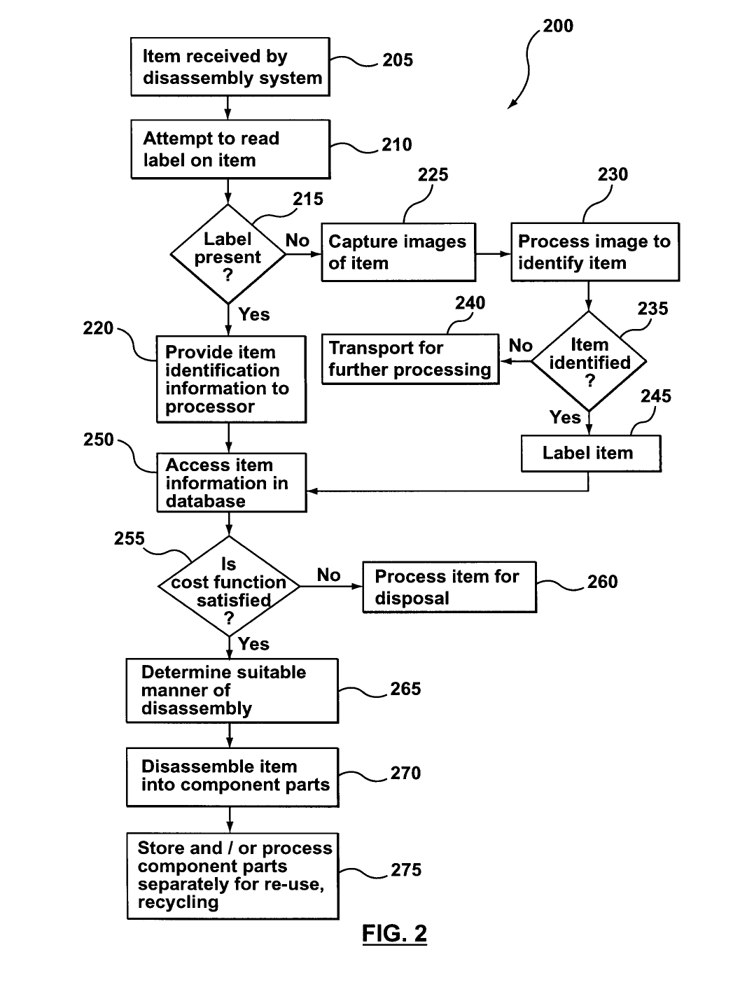

Referring also to FIG. 2, there is shown a method 200 of processing items 105 for recycling, re-use or safe disposal. Method 200 begins at step 205, at which an item 105 is received by system 100 in a disassembly line (on conveyor 115). A step 210, ID reader 110 attempts to read a label 110 on each item 105. If ID reader 120 is able to read label 110 at step 215, the item identification information thus read is provided to an information processor in control system 130, at step 220.

If ID reader 120 is unable to read label 110 or to determine that 110 is even present at step 215, images of the item 105 are captured by an image capture device 125 in communication with control system 130, at step 225. The images of item 105 are processed at step 230 by control system 130 in an attempt to identify the item 105. This processing includes submitting the images to pattern recognition algorithms to determine known shapes, patterns or indicia on or concerned with the item 105. The information discerned from the image processing may be combined with additional information, such as measured dimensions, weight or other characteristics of the item 105, in order to assist in identifying the item.

If the MVIS cannot definitively identify the item 105, it may still be able to generate a short list of candidate item names or descriptions from which a human operator may be able to select one such item name as the identifying name of item 105.

If, at step 235, the item 105 is identified based on the captured and processed images, then at step 245, the item 105 is labeled by a labeling system (not shown) at a labeling station 360 (FIG. 3). If the item 105 cannot be identified at step 235, then item 105 is transported for further processing at step 240. Such further processing may include manual identification, storage or shredding, for example.

Once item 105 is identified, either at step 220 or step 230, the item identification information is used by control system 130 to query database 140 and access item information at step 250. Optionally, control system 130 may use certain item information, such as item constituents, the volume or mass of such constituents, their relative value and the relative ease of extraction of such constituents, in determining whether item 105 satisfies a cost function, at step 255.

The cost function may be satisfied if, for example, the relevant item information yields a cost function value above a threshold amount. The threshold amount may be zero, for example, so that where the estimated cost of recycling the item 105 is greater than the estimated residual value of the item 105, the cost function (which is essentially a consideration of the economic value of recycling the item 105) will be negative and therefore the threshold will not be met and the cost function will not be satisfied. On the other hand, if the cost of recycling the item 105 is less than the estimated residual value of the item 105, then the cost function will be satisfied as it exceeds the zero value threshold.

If, at step 255, the control system 130 determines that the cost function is not satisfied, then at step 260, control system 130 causes robotic disassembly system 150 to process item 105 for disposal without undergoing disassembly. If the cost function is satisfied, then method 200 proceeds with disassembly at step 265.

From the item information accessed at step 250, control system 130 determines a suitable manner of disassembly of the item 105, for example, according to specific disassembly instructions stored in database 140 for that item 105, at step 265. Robotic disassembly system 150 then disassembles item 105, at step 270, according to the determined manner of disassembly. Step 270 may include disassembly of item components into subcomponents, if necessary, and all components and subcomponents are stored in component receptacles 160 or further processed as necessary for specific re-use, recycling or safe disposal purposes, at step 275. Method 200 may be repeated for each item component or subcomponent, as necessary.

Further embodiments relate to a facility 300 for recycling, re-use and refurbishment of manufactured items 105. Facility 300 included multiple instances of disassembly system 100, each being configured for disassembly of particular kinds of items. FIG. 3 illustrates facility 300 by way of example only. In facility 300, an item input stream 310, comprising a continuous or batch input stream of manufactured items 105, is provided to an item sorting system 320 for initial sorting and distribution of items to different disassembly systems 100 within facility 300.

Item sorting system 320 may sort the item input stream 310 based on various factors to direct the items 105 via transport apparatus 330 to different disassembly systems 100 that are configured to disassemble items of a particular type. For example, one or more disassembly systems 100 may be configured to disassemble white goods, such as refrigerators, washing machines, dryers, and ovens, while one or more other disassembly systems 100 may be configured to disassemble computer equipment, such as personal computers, laptops and computer peripherals.

Item sorting system 320 may sort the item input stream 310 according to item characteristics, such as weight, dimensions, apparent materials, electric or magnetic properties and other readily measurable physical characteristics that may indicate the nature of the items 105. Additionally, item sorting system 320 may comprise a MVIS and/or ID reader 120, such as is described above in relation to FIG. 1, to identify items 105 within input item stream 310 and thereby direct such identified items to one or more appropriate disassembly systems 100 within facility 300.

As an example, FIG. 3 shows facility 300 having three item output paths from item sorting system 320, each output path being directed to a disassembly system 100. While the terms “input” and “output” are used in the present context in a process flow sense, it should be understood that these terms correspond to physical transport and handling of the items 105 within and between systems and stations in facility 300. Transport apparatus 330 is provided within facility 300 to effect such transport and handling. Transport apparatus 330 may comprise conveyors, automatically moveable containers and automatic transfer systems and apparatus, as necessary.

The three output paths from item sorting system 320 may be described as comprising a first processing branch 382, a second processing branch 384 and a third processing branch 386. In the first processing branch 382, the output from item sorting system 320 is received at a disassembly system 100, which performs method 200 as described above in relation to FIG. 2 to generate item components. Unlabeled item components may be provided to a labeling station 340 for labeling (where the item component is identifiable) and further disassembly by another disassembly system 100, if necessary. Other item components may be transported to storage 345 or to a shredding station 350, following which they may be further transported to a specific recycling facility, either internal or external to facility 300, as appropriate for the type and characteristics of the stored or shredded item components.

Second processing branch 384 is shown to comprise a disassembly system 100 receiving the output items stream from item sorting system 320. Following initial disassembly, item components may then be provided to a further disassembly system 100 configured for disassembly of the item components into subcomponents or subassemblies, which may then be transported for further processing or provided to one or more specific recycling facilities 355.

In the example shown in FIG. 3, disassembled item components or subcomponents or subassemblies may be provided from the second processing branch 384 to another disassembly system 100 within the first processing branch 382, for example in order to take advantage of a particular disassembly system 100 that is configured to disassemble item components or subcomponents in a manner not available to disassembly systems within the second processing branch 384. Although not specifically illustrated in FIG. 3, second processing branch 384 may comprise one or more labeling stations 340, storage facilities 345 and shredding stations 350, as necessary.

Third processing branch 386 receives output from item sorting system 320 at a disassembly system 100 via transport apparatus 330. In the example illustrated in processing branch 386, the output of disassembly system 100 may be divided up into separate streams, part of which may be transported to a labeling station 340 and part of which may be transported to recycling facility 355. Further, part of the output of disassembly system 100 may also be provided to a manual handling station 365, either directly or via labeling station 340. Further, following labeling of item components at labeling station 340, some of those components may be provided to a further disassembly system 100 for further disassembly, as required.

It should be emphasized that the systems and stations illustrated in FIG. 3 in relation to facility 300 are exemplary only, with respect to the number, order and interrelation of such systems and stations. Further, additional ones of the described systems and stations (including labeling stations 340, storage 345, shredding stations 350, recycling facilities 355, manual handling stations 365 and disassembly systems 100) may be utilized in the described processing branches and in additional processing branches, as necessary. Further, additional processing stations may be employed, where necessary or desirable for identification, cleaning, chemical treatment or other steps appropriate for the purpose of recycling manufactured items 105, their item components and subcomponents.

While the described embodiments are presented by way of example only, it should be understood that some modifications may be made to the features and/or functions of the described embodiments, without departing from the spirit and scope of the invention. Accordingly, the described embodiments are intended to be presented by way of non-limiting example.

1. A system for recycling a manufactured item having at least one information medium attached thereto for storing or representing item information associated with the item, the system comprising:
information reading apparatus to automatically read the at least one information medium;
an information processing system in communication with the information reading apparatus to determine item information from the at least one information medium, the item information including item identification data, and to determine disassembly instructions based on the item identification data; and
robotic disassembly apparatus in communication with the information processing system and responsive to the disassembly instructions to disassemble the item according to the disassembly instructions into item components and to separate the item components for separate recycling of the item components.

2. The system of claim 1, wherein the item identification data comprises a link to disassembly instructions accessible to the information processing system.

3. The system of claim 1, further comprising a database stored on a computer-readable storage medium accessible to the information processing system and storing a plurality of data records, each of the plurality of data records corresponding to a manufactured item, and comprising disassembly instructions for the manufactured item wherein the information processing system is configured to access the database using the item information to determine the disassembly instructions.

4. The system of claim 3, wherein each data record further comprises constituent data identifying constituent components of the manufactured item.

5. The system of claim 3, wherein each data record further comprises dimensional data defining physical dimensions of the manufactured item.

6. The system of claim 5, further comprising transport apparatus to transport the separate item components to respective component stations for further processing.

7. The system of claim 6, wherein, for each item component, the further processing comprises at least one of: transport to a recycling station; storage; further disassembly; shredding; and labeling the item component with a further information medium comprising a unique identifier of the item component.

8. The system of claim 4, wherein the information processing system is configured to determine whether the manufactured item satisfies a cost function based at least in part on the constituent data, wherein if the manufactured item is determined to satisfy the cost function, the information processing system provides the disassembly instructions to the robotic disassembly apparatus to disassemble the manufactured item.

9. The system of claim 8, wherein if the manufactured item is determined not to satisfy the cost function, the information processing system instructs the robotic disassembly apparatus to transport the manufactured item to an alternative processing station.

10. The system of claim 9, further comprising an image database stored on a computer-readable storage medium and an image capture system in communication with the image database to capture and process images of the manufactured item or at least one of the item components and access the image database to identify the manufactured item or the at least one item component.

11. The system of claim 9, wherein the constituent data identifies one of: all constituent components of the manufactured item; and partial constituent components of the manufactured item and one or more references to data records in the database corresponding to item components.

12-14. (canceled)

15. A method for automated recycling of a manufactured item having at least one information medium attached thereto, the method comprising:
automatically reading the at least one information medium;
determining item information associated with the item based on the at least one information medium, the item information including item identification data;
determining item disassembly data based on the item identification data;
causing a robotic disassembly system to automatically disassemble the manufactured item according to the item disassembly data into item components; and
separating the item components for separate recycling of the item components.

16. The method of claim 15, wherein determining the item disassembly data comprises accessing a database stored on a computer-readable storage medium that includes a data record comprising the item identification data and the item disassembly instructions.

17. The method of claim 16, wherein each data record of the database further comprises constituent data identifying constituent components of the manufactured item.

18. The method of claim 16, wherein each data record of the database further comprises dimensional data defining physical dimensions of the manufactured item.

19. The method of claim 15, further comprising transporting the separate item components to respective component stations for further processing.

20. The method of claim 19, wherein, for each item component, the further processing comprises at least one of: transporting to a recycling station; storage; further disassembling; shredding; and labeling the item component with a further information medium comprising a unique identifier of the item component.

21. The method of claim 17, further comprising determining whether the manufactured item satisfies a cost function based at least in part on the constituent data and, if the cost function is satisfied, disassembling the manufactured item.

22. The method of claim 21, further comprising, if the cost function is not satisfied, transporting the manufactured item to an alternative processing station.

23. The method of claim 17, wherein the constituent data identifies one of: all constituent components of the manufactured item; and partial constituent components of the manufactured item and one or more references to data records in the database corresponding to item components.

24. The method of claim 15, further comprising capturing and processing images of the manufactured item or at least one of the item components and identifying the manufactured item or the at least one item component based on the images.

25. The method of claim 15, wherein the at least one information medium comprises a label.

26. The method of claim 25, wherein the label comprises one or more of: a one-dimensional bar code symbol, a two-dimensional bar code symbol, a RFID tag, a passive transceiving device, an active transceiving device and symbols readably by Optical Character Recognition (OCR).

27. A system for facilitating recycling of a manufactured item having at least one information medium attached thereto for storing or representing item information associated with the item, the system comprising:
information reading apparatus to automatically read the at least one information medium;
an information processing system in communication with the information reading apparatus to determine item information from the at least one information medium, the item information including item identification data and item constituent data, and to determine whether the manufactured item satisfies a cost function based at least in part on the item identification data and the item constituent data; and
automatic handling apparatus in communication with the information processing system to process the item for disassembly and recycling of the item if the information processing system determines that the cost function is satisfied and to process the item for disposal if the cost function is not satisfied.

28. The system of claim 27, wherein the at least one information medium comprises a label.

29. The system of claim 28, wherein the label comprises one or more of: a one-dimensional bar code symbol, a two-dimensional bar code symbol, a RFID tag, a passive transceiving device, an active transceiving device and symbols readably by Optical Character Recognition (OCR).

30. The system of claim 27, wherein the item identification data comprises a link to disassembly instructions accessible to the information processing system.

31. The system of claim 27, further comprising a database stored on a computer-readable storage medium accessible to the information processing system and including a plurality of data records, each of the plurality of data records corresponding to a manufactured item, and comprising disassembly instructions for the manufactured item wherein the information processing system is configured to access the database using the item information to determine the disassembly instructions.

32. The system of claim 27, wherein the automatic handling apparatus further comprises robotic disassembly apparatus responsive to disassembly instructions received from the information processing system to disassemble the manufactured item according to the disassembly instructions into item components and to separate the item components for separate recycling or disposal of the item components.

33. The system of claim 32, further comprising transport apparatus to transport the separate item components to respective component stations for further processing.

34. The system of claim 33, wherein, for each item component, the further processing comprises at least one of: transport to a recycling station; storage; further disassembly; shredding; and labeling the item component with a further information medium comprising a unique identifier of the item component.

35. A method for automated recycling of a manufactured item having at least one information medium attached thereto, the method comprising:
automatically reading the at least one information medium;
determining item information associated with the item based on the at least one information medium, the item information including item identification data and item constituent data;
determining whether the manufactured item satisfies a cost function based at least in part on the item identification data and the item constituent data;
processing the manufactured item for disassembling and recycling of the item if the cost function is satisfied; and
processing the manufactured item for disposal if the cost function is not satisfied.
